(19) United States
(12) Patent Application Publication
(10) Pub. No.: US 2015/0076157 A1
(43) Pub. Date: Mar. 19, 2015

(54) Pan with grease trap

(71) Applicant: Alan Rine, Bakersfield, CA (US)

(72) Inventor: Alan Rine, Bakersfield, CA (US)

(21) Appl. No.: 13/971,016

(22) Filed: Sep. 16, 2013

(51) Int. Cl. A47J 27/12

(52) U.S. Cl. CPC A47J 27/12
USPC 220/573.1

(57) ABSTRACT

A cooking pan for trapping grease comprising a convex upper surface having an axially disposed bore; a grease trap disposed directly below the axial bore for trapping grease and other materials; an outer surface extending perpendicular from the edge of the upper surface and adapted to form a base; handles disposed on the outer surface; and the cooking pan comprising materials sufficient to withstand oven temperatures. Alternatively, the cooking pan having a range of convexity of 1 to 18 degrees; or two or more fixed or telescoping legs extending generally perpendicular from the edge of the upper surface; or a screen adapted to trap non-liquid materials; or, wherein the grease trap is removable.

### FIELD OF THE INVENTION

The present invention relates to a pan for trapping grease. More specifically, the present invention relates to a durable, oven-proof pan with a convex surface whereby grease flowing from cooking food items, such as pizza, is directed toward a grease trap disposed at the bottom of the convex surface.

### BACKGROUND OF THE INVENTION

Typical pans for baking food items, especially pizzas, do not allow for any excess grease to collect when cooking. As such, grease will then pool at the bottom of the food item and make it less suitable for consumption. Other pans may have perforations but nothing to conveniently collect any unwanted grease or other liquid or food materials that drain away from the food item.

### SUMMARY OF THE PREFERRED EMBODIMENT

A cooking pan for trapping grease comprising a convex upper surface having an axially disposed bore; a grease trap disposed directly below the axial bore for trapping grease and other materials; An outer surface extending perpendicular from the edge of the upper surface and adapted to form a base; handles disposed on the outer surface; and the cooking pan comprising materials sufficient to withstand oven temperatures.

Alternatively, the cooking pan having a range of convexity of 1 to 18 degrees.

Alternatively, the cooking pan further comprising a generally circular upper surface.

Alternatively, the cooking pan further comprising a base comprised of two or more fixed legs extending generally perpendicular from the edge of the upper surface.

Alternatively, the cooking pan further comprising a base comprised of two or more telescoping legs extending generally perpendicular from the edge of the upper surface.

Alternatively, the cooking pan wherein the grease trap further comprises a screen adapted to trap non-liquid materials.

Alternatively, the cooking pan wherein the grease trap is removable.

Alternatively, the cooking pan further comprising a generally circular convex upper surface having a convexity range of 1 to 18 degrees; a generally circular axial bore and grease trap and wherein the grease trap is removable; and cut-out handles disposed on the outer surface.

Alternatively, the cooking pan of claim 1 further comprising a generally circular convex upper surface having a convexity range of 1 to 18 degrees; a generally circular axial bore and grease trap and wherein the grease trap is removable; and two or more legs extending generally perpendicular from the edge of the upper surface to form the base.

### BRIEF DESCRIPTION OF THE DRAWINGS

FIG. 1 is an elevated top perspective view of a pan having a convex surface adapted to direct fluids through an axial bore and into a grease trap.

FIG. 2 is a side cross-sectional view of a pan having a convex surface adapted to direct fluids through an axial bore and into a grease trap.

FIG. 3 is a top view of a pan having a convex surface adapted to direct fluids through an axial bore and into a grease trap.

FIG. 4 is a bottom perspective view of a pan having a convex surface adapted to direct fluids through an axial bore and into a grease trap.

FIG. 5 is a side view of a pan having a convex surface adapted to direct fluids through an axial bore and into a grease trap.

FIG. 6 is a side view of a pan with a grease trap with a removable screen

### DETAILED DESCRIPTION

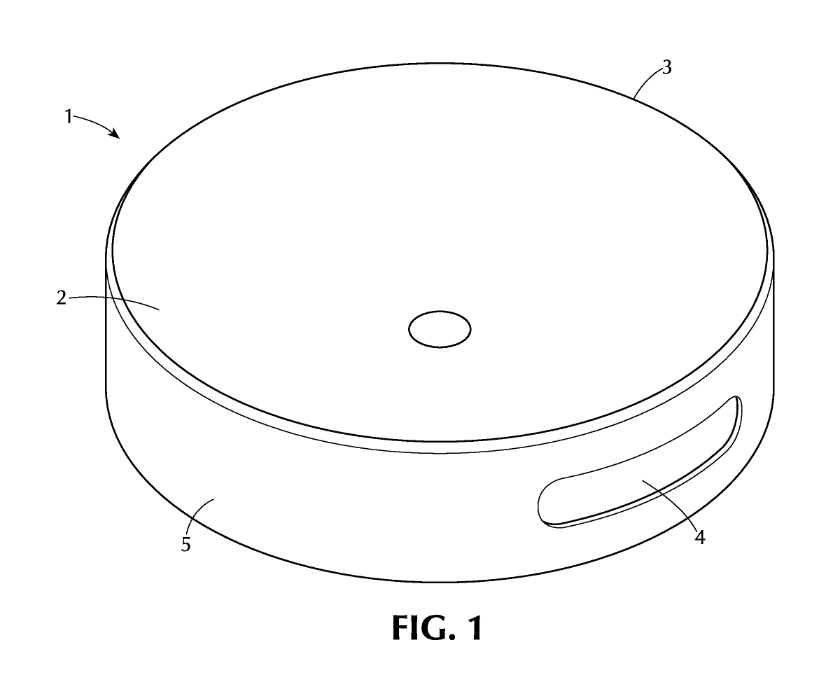

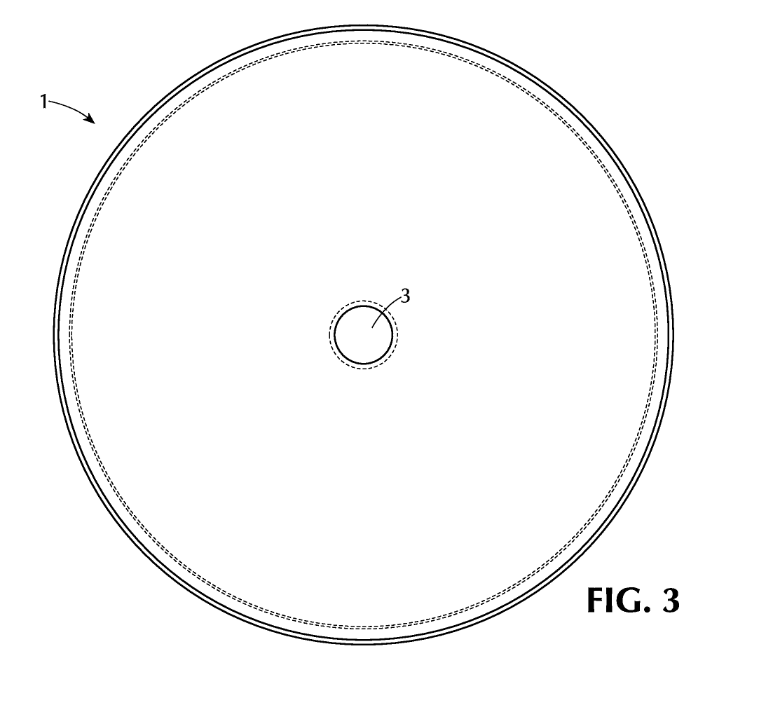

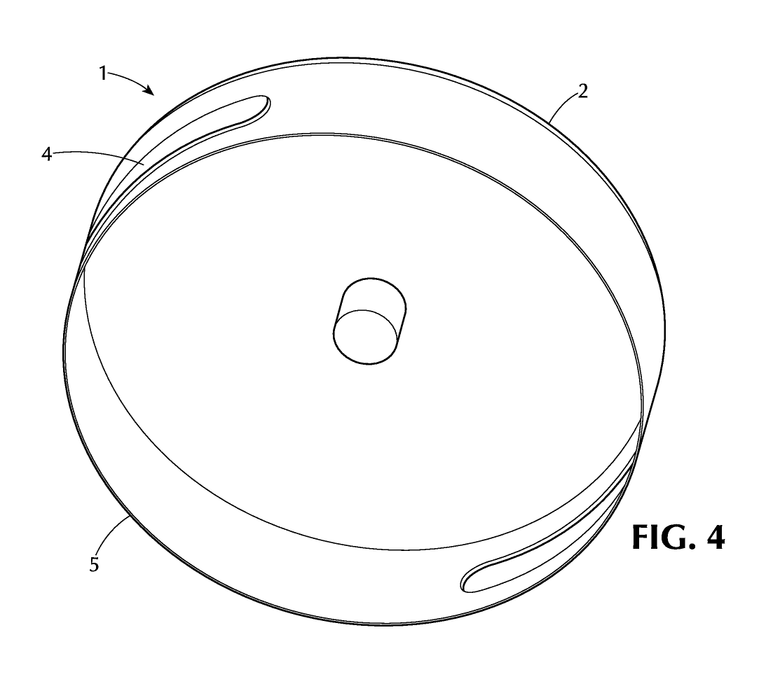

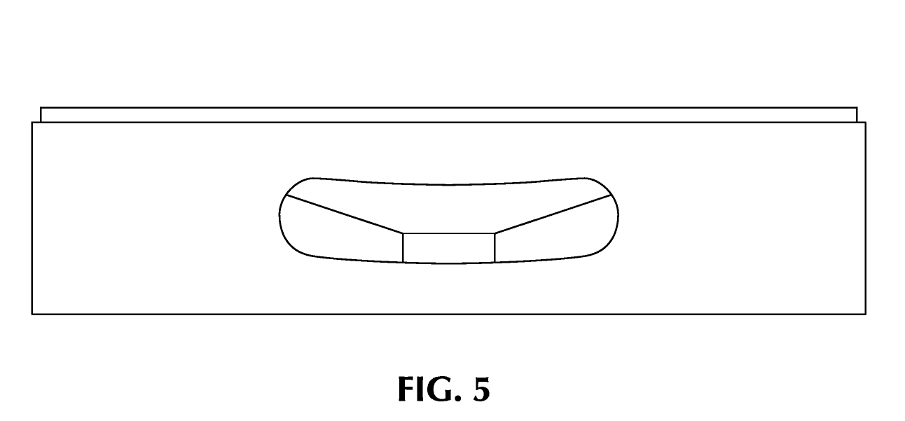

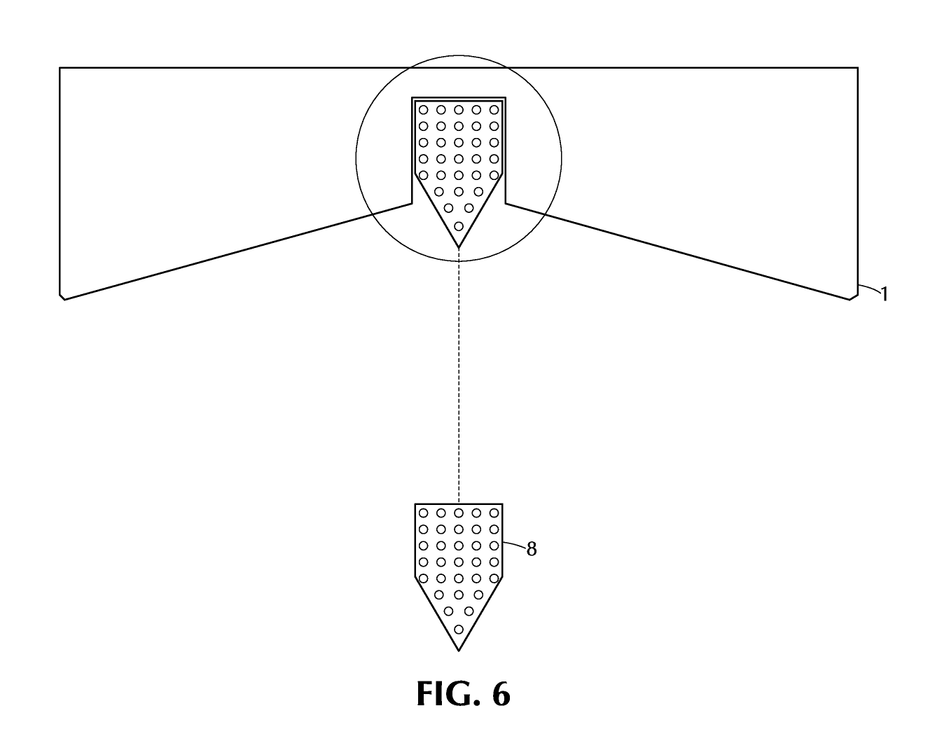

Referring to FIGS. 1-6 the present invention is directed to a pan made from durable, oven-ready materials capable of withstanding high temperatures during the cooking process.

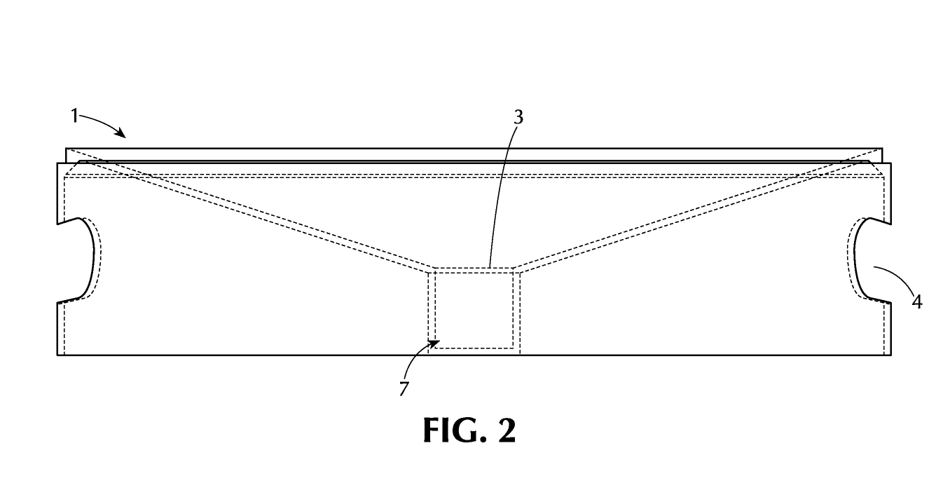

In a preferred embodiment surface 2 of a pan 1 with a grease trap 3 7 (See. FIGS. 1 and 2) is concave and which allows fluids such as grease to be directed downward through an aperture or bore 3 in pan 1 and collect in a trap 7. Preferably, pan 1 is oval in shape so as to accommodate common baking items such as pizzas but, those skilled in the art will appreciate that any pan can be adapted or formed into a convex shape to achieve the same result. The angle of concavity is preferably in the range of 1 to 18 degrees (See FIG. 2) and which is the optimal range to both allow for gravity flow of any excess fluids but also to sustain a food product, such as a pizza, to retain its desired form.

Although the Figures illustrate a pan with a single concave surface, multiple angles of concavity can be accomplished or coupled together to form a single pan with multiple concave cooking surfaces.

In a preferred embodiment base 5 is formed from an extended surface generally perpendicular from an outer edge of surface 2 and extends sufficiently to exceed the length of trap 7 so as to allow pan 1 to rest on a surface. In a preferred embodiment, base 5 comprises a single annular outer extended surface. However, a base comprised of more than one extended surface can achieve the same result.

In another preferred embodiment a pan may be adapted with two or more legs extending outward from the bottom of the surface 2 and whereby the legs (not shown) can be either fixed or telescoping to accommodate for storage.

In a preferred embodiment, handles 4 in the form of a cutout(s) in the outer surface 5 can be formed to allow a user to carry the pan. (See, e.g., FIGS. 1-2) However, and although the handles as shown disclose cutouts ovular in shape, those skilled in the art will appreciate there are a variety of shapes susceptible of being adapted in the shape of a handle.

Further, and in another preferred embodiment, one or more handles (not shown) can be disposed on an outer surface or otherwise affixed to a pan and which are not cutout in nature but extending handles of various types.

In another preferred and exemplary embodiment, a grease trap is comprised of a combination of an axial bore 3 that is centrally located at or near the bottom or the center of the angle of concavity of the pan and a trap 7. (See, FIG. 2) As shown in the figures, bore 3 is circular in nature although any shape that will allow for fluid to flow through it and into the trap 7 will suffice. Further, and depending on function, more than one bore can be disposed on the surface of a pan and strategically positioned so as to capture fluids at more than one location. These multiple trap combinations can either be at different locations on a single concave surface or axially positioned on multiple concave surfaces. (not shown)

In a preferred embodiment a trap 7 is adapted for placement internal to bore and trap 7 so as to capture fluids flowing downward from the surface of a pan. Trap 7 in the preferred embodiment screen 8 is removable and shaped in the form a thimble with perforations sufficiently small enough to allow fluids such as grease to enter the trap and prevent larger food particles from entering the trap. In another preferred embodiment (not shown) a trap is molded or fixed onto the bottom of pan surface. For example, a trap may be removable from the underside of a pan through a slotted channel arrangement whereby opposing channels allow a trap to be removed. Or, in another preferred embodiment, a trap may be threadable onto the bottom of a pan. Or, other means of connection such as magnetic attachment or other known attachments can accomplish the same purpose. In another preferred embodiment a flat screen mesh can be permanently or removably secured adjacent to bore and above trap to accomplish the same result.

Although the embodiment shown in the Figures illustrates a thimble shaped trap, any shape sufficient to achieve the purpose of the invention may be used.

The foregoing embodiments are merely examples of the present invention. Those skilled in the art may make numerous uses of, and departures from, such embodiments without departing from the scope of the present invention. Accordingly, the scope of the present invention is not limited to or defined by such embodiments in any way but, rather, is defined solely by the following claims.

I claim:

1. A cooking pan for trapping grease comprising:
a pan having a convex upper surface with an axially disposed bore;
a grease trap operatively engaging the pan and disposed below the axial bore for trapping grease;
an outer surface extending perpendicular from the edge of the upper surface and adapted to form a base;
on ore more handles disposed on the outer surface; and
the pan comprising materials sufficient to withstand oven temperatures.

2. The cooking pan of claim 1 wherein the angle of convexity is 1-18 degrees.

3. The cooking pan of claim 1 further comprising a generally circular upper surface.

4. The cooking pan of claim 1 further comprising a base comprised of two or more fixed legs extending generally perpendicular from the edge of the upper surface.

5. The cooking pan of claim 1 further comprising a base comprised of two or more telescoping legs extending generally perpendicular from the edge of the upper surface.

6. The cooking pan of claim 1 wherein the grease trap further comprises a screen adapted to trap non-liquid materials.

7. The cooking pan of claim 1 wherein the grease trap is removably secured to the underside of the pan.

8. The cooking pan of claim 1 further comprising:
a generally circular convex upper surface having an angle of convexity of 1 to 18 degrees;
a generally circular axial bore and wherein the grease trap is removable; and
one or more cut-out handles disposed on the outer surface.

9. The cooking pan of claim 1 further comprising:
a generally circular convex upper surface having an angle of convexity of 1 to 18 degrees;
a generally circular axial bore;
the grease trap is removable; and
two or more legs extending generally perpendicular from the edge of the upper surface to form the base.
